(19) United States
(12) Patent Application Publication
(10) Pub. No.: US 2004/0196222 A1
(43) Pub. Date: Oct. 7, 2004

(54) Method for driving organic light emitting diodes and related circuit

(76) Inventors: Li-Wei Shih, Chia-Yi Hsien (TW); Chun-Huai Li, Ping-Tung Hsien (TW)

Correspondence Address: NAIPO (NORTH AMERICA INTERNATIONAL PATENT OFFICE), P.O. BOX 506, MERRIFIELD, VA, 22116, US

(21) Appl. No.: 10/707,439

(22) Filed: Dec. 15, 2003

(30) Foreign Application Priority Data
Apr. 7, 2003 (TW) 092107923

(51) Int. Cl. G09G 3/32

(52) U.S. Cl. 345/82

(57) ABSTRACT

A method for driving an organic light emitting diode (OLED). The method adjusts the voltage at an end of a capacitor connected to a gate of a metal oxide semiconductor (MOS) transistor serially connected to the OLED when the MOS transistor is actuated and emits the currents for the OLED to emit light.

### BACKGROUND OF INVENTION

1. Field of the Invention

The present invention relates to an organic light emitting diode (OLED), and more particularly, to a method for driving the OLED and related OLED driving circuit.

2. Description of the Prior Art

Having a variety of advantages, such as high light intensity, high response velocity, wide viewing angle, spontaneous light source and thin appearance, an organic light emitting diode (OLED) is becoming one of the most popular light emitting components that form a display device.

An OLED is a current-driving component. That is, the intensity of light (gray scale) emitted by an OLED can be controlled by determining currents flowing through the OLED.

A method for controlling the intensity of light emitted by an OLED by adjusting levels of currents flowing through the OLED is to adjust a voltage at a gate of a thin film transistor (TFT) serially connected to the OLED to control the levels of currents flowing through the OLED and to control the intensity of light emitted by the OLED. The TFT and the OLED combine to form an active display cell. The larger a voltage difference between the gate and a source of the TFT is, the greater the currents flowing through the OLED are and the larger the gray scale that the OLED performs becomes, and vice versa.

In the process that the TFT drives the OLED, not only the quality of the OLED dominates the performance of images displayed by the active display cell, but also how stable a threshold voltage of a transistor used to drive the TFT can be sustained is a key factor in determining whether the active display cell can display for a long enough period of time or not. Please refer to FIG. 1, which is a circuit diagram of an active display cell 10 according to the prior art. The cell 10 comprises a PMOS transistor T₁ and an OLED 80 serially connected to the PMOS T₁. A source, a gate and a drain of the PMOS T₁ are connected to a first voltage source V_{dd}, a control voltage source V_{C} and an anode of the OLED 80 respectively. A cathode of the OLED 80 is connected to a second voltage source V_{SS}.

When a voltage generated by the control voltage V_{C} is too small to turn on the PMOS T₁ the PMOS T₁ does not actuate any currents and the OLED 80 serially connected to the PMOS T₁ does not emit light either. On the contrary, when the control voltage source V_{C} generates a voltage that is large enough to turn on the PMOS T₁, the PMOS T₁ is turned on and actuates its currents capable of enabling the OLED 80 to emit light. Since the OLED 80 is an electronic component meant for emitting light, the PMOS T₁ flows all the time the currents are capable of driving the OLED 80 to emit light. Whenever the PMOS T₁ has currents flowing through, current carriers (holes for PMOS) are to flow along a direction directed by a first electric field E₁ all the way from the source to the drain of the PMOS T₁, and some current carriers may accumulate at a region between the source and the drain of the PMOS T₁, resulting in a decrease of a threshold voltage Vₜₕₚ of the PMOS T₁.

Please refer to an equation 1, l_{d p}=K(V_{gs p}+V_{th p})², which is a relation of a current I_{dp} flowing through the PMOS T₁ and a difference between a voltage difference V_{gsp} between the gate and the source of the PMOS T₁ and the threshold voltage Vₜₕₚ of the PMOS T₁. It can be seen from the equation 1 that when the voltage difference V_{gsp} is kept constant, the current I_{dp} flowing through the PMOS T₁ drops as the threshold voltage Vₜₕₚ of the PMOS T₁ decreases. Therefore, currents flowing through the PMOS T₁ controlled by a constant voltage, voltage difference V_{gsp} between the date and the source of the PMOS T₁, will diminish as time goes by and the OLED 80 can only emit dimmer and dimmer light.

In FIG. 1, what the active display cell 10 utilizes to control the OLED 80 to emit light is the PMOS T₁. However, the active display cell 10 can comprise an NMOS to control operations of the OLED 80 instead. Please refer to FIG. 2, which is a circuit diagram of a second active display cell 20 according to the prior art. The cell 20 comprises an NMOS T₂ and an OLED 82 serially connected to the NOMS T₂. A source, a gate and a drain of the NMOS T₂ are connected to a second voltage source V_{SS}, the control voltage source V_{C} and a cathode of the OLED 82. An anode of the OLED 82 is connected to the first voltage source V_{dd}.

When the control voltage source V_{C} generates a voltage to turn off the NMOS T₂, the NMOS T₂ does not generate any currents and the OLED 82 serially connected to the NMOS T₂ does not emit any light either. On the contrary, when a voltage that the control voltage source V_{C} generates is large enough to turn on the NMOS T₂, the NMOS T₂ will actuate currents capable of enabling the OLED 82 to emit light. Whenever the NMOS T₂ has currents flowing through, current carriers (electron for NMOS) will flow along a direction opposite to a direction directed by a second electron field E₂ all the way from the source to the drain of the NMOS T₂, and some of the current carriers may accumulate at a region between the source and the gate of the NMOS T₂, resulting in an increase of a threshold voltage Vₜₕₙ of the NMOS T₂.

Please refer to an equation 2, I_{d n}=K(V_{gs n}−V_{th n})², which shows a relation between a current I_{dn} flowing through the NMOS T₂ and a difference between a voltage difference V_{gsn} between the gate and the source of the NMOS T₂ and a threshold voltage Vₜₕₙ of the NMOS T₂. The equation 2 shows that when the voltage difference V_{gsn} is kept constant, the current I_{dn} drops as the threshold voltage Vₜₕₙ increases. Therefore, currents flowing through the NMOS T₂ controlled by a constant voltage, voltage difference V_{gsn} between the date and the source of the NMOS T₂, will diminish as time goes by and the OLED 82 can only emit dimmer and dimmer light.

### SUMMARY OF INVENTION

It is therefore a primary objective of the claimed invention to provide a method for driving an OLED to overcome the drawbacks of the prior art.

According to the claimed invention, the method comprises following steps: (a) providing a first metal oxide semiconductor (MOS) transistor, whose first and second ends are connected to an OLED and to a first voltage source respectively; (b) providing a capacitor, whose first end is connected to a gate of the first MOS transistor; (c) providing a second MOS transistor, whose first end is utilized for inputting data, a second end of the second MOS transistor being connected to the first end of the capacitor; (d) turning on the second MOS transistor and inputting data from the first end of the second MOS transistor to the second end of the second MOS transistor; and (e) turning off the second MOS transistor after step (d), and adjusting a voltage at a second end of the capacitor from a first voltage level to a second voltage level different from the first voltage level sequentially for enabling a voltage at the first end of the capacitor to control currents flowing through the OLED.

It is an advantage of the claimed invention that a method to drive an OLED by adjusting a voltage at the gate of the first transistor and by decreasing currents flowing through the first transistor when the OLED is actuated to emit light omits the possibility of charge accumulation and stabilizes the Vₜₕ.

These and other objectives of the claimed invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a circuit diagram of a first active display cell according to the prior art.

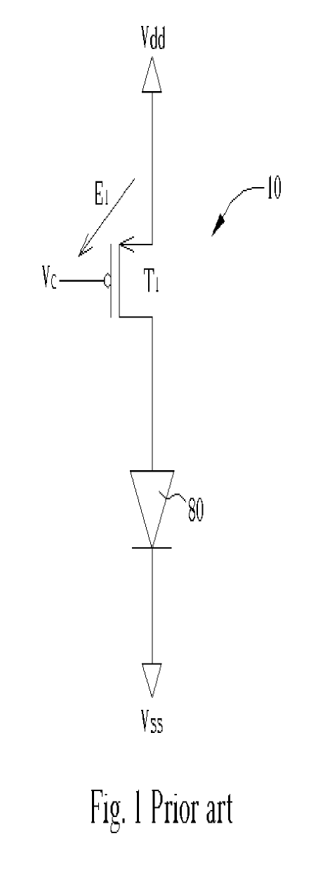

FIG. 2 is a circuit diagram of a second active display cell according to the prior art.

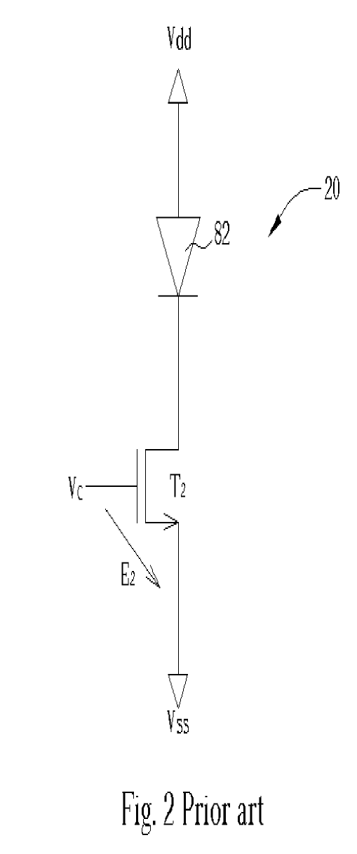

FIG. 3 is a circuit diagram of a driving circuit to drive an OLED according to the present invention.

FIG. 4 is a first timing diagram of a first reference voltage source applied to the driving circuit shown in FIG. 3 according to the present invention.

FIG. 5 is a second timing diagram of a first reference voltage source applied to the driving circuit shown in FIG. 3 according to the present invention.

FIG. 6 is a third timing diagram of a first reference voltage source applied to the driving circuit shown in FIG. 3 according to the present invention.

FIG. 7 is a circuit diagram of a second active display cell to drive an OLED according to the present invention.

FIG. 8 is a first timing diagram of a first reference voltage source applied to the driving circuit shown in FIG. 7 according to the present invention.

FIG. 9 is a second timing diagram of a first reference voltage source applied to the driving circuit shown in FIG. 7 according to the present invention.

FIG. 10 is a third timing diagram of a first reference voltage source applied to the driving circuit shown in FIG. 7 according to the present invention.

### DETAILED DESCRIPTION

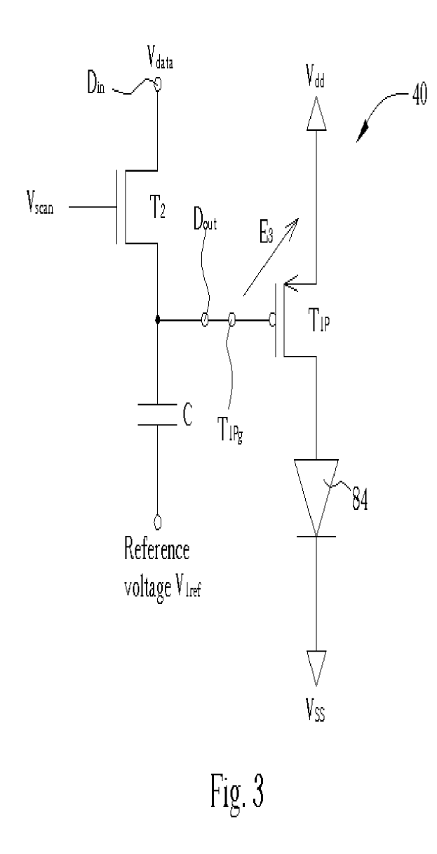

Please refer to FIG. 3, which is a circuit diagram of a first driving circuit 40 to drive an OLED 84 according to the present invention. The driving circuit 40 comprises a first PMOS T₁ₚ, a capacitor C and a second MOS T₂ for inputting data at an input end Dᵢₙ. A first end of the first PMOS T₁ₚ is connected to an anode of the OLED 84. A second end of the PMOS T₁ₚ is connected to a first voltage source V_{dd}. A first end and a second end of the capacitor C are connected to a gate T_{1Pg} of the PMOS T1p and a reference voltage source V_{1ref} respectively. An output end Dₒᵤₜ of the second MOS T₂ is connected to the first end of the capacitor C. A control end of the second MOS T₂ is connected to a scan voltage source V_{scan}. The first PMOS T₁ₚ can be a TFT transistor.

Operations of the driving circuit 40 are described as follows: controlling the scan voltage source V_{scan} to continue to output a voltage to turn on the second MOS transistor T₂ so that data at the input end Dᵢₙ of the second transistor T₂ can be transmitted to the output end Dₒᵤₜ of the second transistor T₂ (the first end of the capacitor C) until a voltage at the first end of the capacitor C (the gate T_{1Pg} of the first PMOS transistor T₁ₚ) is charged to a voltage equal to a data voltage V_{data} of the input data, resulting that currents flowing through the first PMOS transistor T₁ₚ for controlling the intensity of light emitted by the OLED 84 at this moment vary with the change of a voltage at the gate T_{1Pg} of the first PMOS transistor T₁ₚ (the first end of the capacitor C, the data voltage V_{data}). That is, the lower the data voltage V_{data} is, the lower the voltages at the first end of the capacitor C and the gate T_{1Pg} of the first PMOS transistor T₁ₚ become. A voltage at the gate T_{1Pg} of the first PMOS transistor T₁ₚ having a high enough voltage level actuates the first PMOS transistor T₁ₚ to flow with currents of greater current levels and drive the OLED 84 to emit light of greater intensity levels, accomplishing a function performed by the driving circuit 40 to adjust the intensity of light emitted by the OLED 84 according to the data (the data voltage V_{data}).

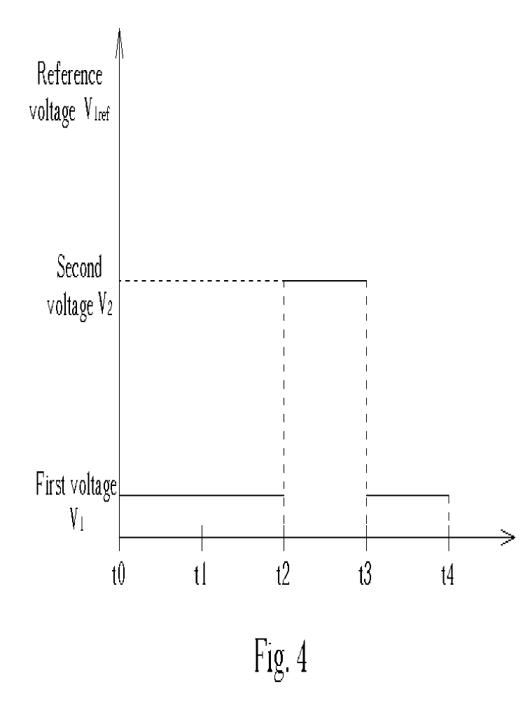

After the voltage at the first end of the capacitor C is charged to be of a voltage level equal to the data voltage V_{data} of the data, controlling the scan voltage source V_{scan} to output a voltage at a time t₁ to turn off the second transistor T₂ and turning off the second transistor T₂, and adjusting a voltage of the first reference voltage source V_{1ref} sequentially. Please refer to FIG. 4, which is a timing diagram of the first reference voltage source V_{1ref} of the driving circuit 40 according to the present invention. The first reference voltage source V_{1ref} generates a first voltage V₁ during intervals from times to to t₂ and from times t₃ to t₄, and generates a second voltage V₂ during a remaining interval from times t₂ to t₃. The time t₀ shown in FIG. 4 is almost simultaneous with or slightly lags a time when the scan voltage source V_{scan} starts to output the voltage to turn on the second transistor T₂, while the time t₁ shown in FIG. 4 is a time when the scan voltage source V_{scan} starts to output the voltage to turn off the second transistor T₂. A voltage difference between the first and the second end of the capacitor C at the time t₁ is equal to a voltage subtracted by the first voltage V₁ from the data voltage V_{data}. Because the second transistor T₁ is kept turned off after the time t₁, charges stored in the capacitor C has no way to flow and the voltage difference between the first and the second end of the capacitor C does not change at all. As the first reference voltage source V_{1ref} generates the first voltage V₁ during the intervals from times t₁ to t₂ and from times t₃ to t₄, a voltage at the first end of the capacitor C is equal to the data voltage V_{data}. As the first reference voltage source V_{1ref} generates the second voltage V₂ during the interval from times t₂ to t₃, the voltage at the first end of the capacitor C is equal to the data voltage V_{data}+(the second voltage V₂ the first voltage V₁). A voltage increased at the first end of the capacitor C (the second voltage V₂ the first voltage V₁) forms an electric field E₃, whose direction is opposed to the direction of the electric field E₁, on a region between the source and the gate T_{1Pg} of the first PMOS transistor T₁ₚ equivalently. The electric field E₃ decreases a number of holes accumulated in the region between the source and the gate T_{1Pg} of the first PMOS transistor T₁ₚ, therefore accomplishing the goal to stabilize the threshold voltage Vₜₕ and to enable the PMOS T₁ₚ to emit stable currents under a stable gate voltage, so as to enable the OLED to emit stable light.

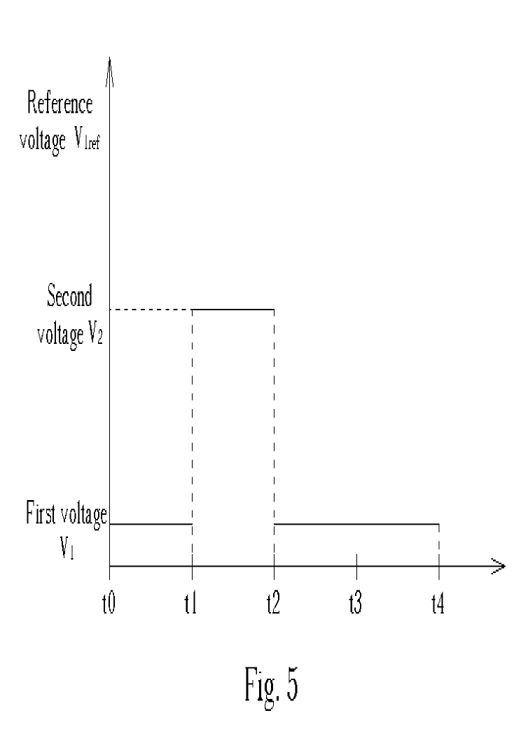

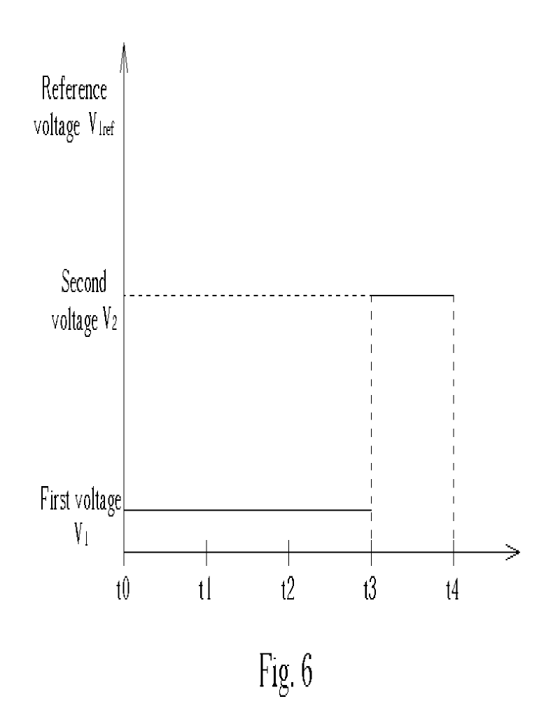

The first reference voltage source V_{1ref} shown in FIG. 4 generates the second voltage V₂, whose level is higher than that of the first voltage V₁, during the interval from times t₂ to t₃. The first reference voltage source V_{1ref} can also surely generate the second voltage V₂ during other intervals in addition to the interval from times t₂ to t₃. Please refer to FIG. 5 and to FIG. 6, which are two timing diagrams of the first reference voltage source V_{1ref} according to the present invention. In FIG. 5, the first reference voltage source V_{1ref} generates the second voltage V₂ during the interval from times t₁ to t₂ while generating the first voltage V₁ during the remaining intervals, so charges accumulated during the interval from times t₁ to t₂ can be released can the threshold voltage Vₜₕ can be kept stable. In FIG. 6, the first reference voltage source V_{1ref} generates the second voltage V₂ during the interval from times t₃ to t₄ while generating the first voltage V₁ during the remaining intervals, so charges accumulated during the interval from times t₃ to t₄ can be released can the threshold voltage Vₜₕ can be kept stable.

Since a value of gray scales performed by an OLED relates to the levels of currents flowing through the OLED, the greater the currents flowing through the OLED are, the larger the value of gray scale performed by the OLED becomes.

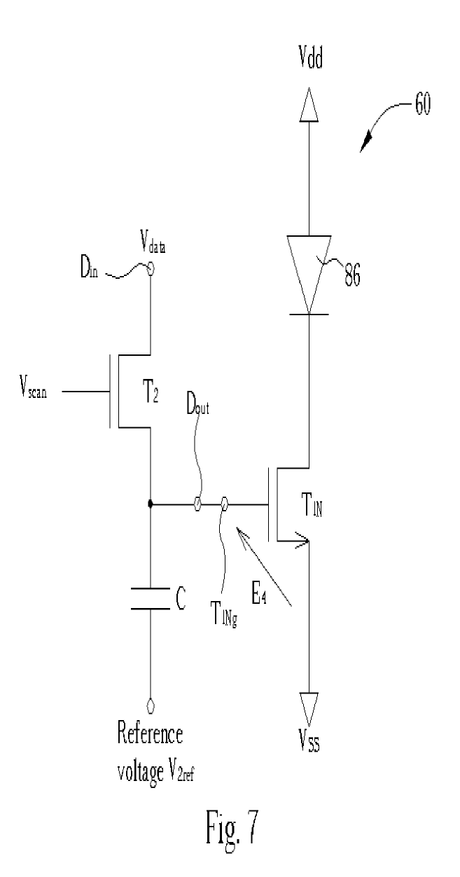

The first PMOS transistor T₁ₚ of the driving circuit 40 for driving the OLED 84 can be substituted by an NMOS transistor. Please refer to FIG. 7, which is a circuit diagram of a second driving circuit 60 for driving an OLED 86 according to the present invention. The driving circuit 60 comprises a first NMOS transistor T₁ₙ, the second MOS transistor T₂ and the capacitor C. A first end of the first NMOS transistor T₁ₙ is connected to a cathode of the OLED 86. A second end of the first NMOS transistor T₁ₙ is connected to a second voltage source V_{SS}. The first end of the capacitor C is connected to a gate T_{1ng} of the first NMOS transistor T₁ₙ(1N?). The second end of the capacitor C is connected to a second reference voltage source V_{2ref}. The input end Dᵢₙ of the second MOS transistor T₂ of the driving circuit 60 is also utilized to input data. The output end Dₒᵤₜ of the second MOS transistor T₂ is connected to the first end of the capacitor C. The control end of the second MOS transistor T₂ is connected to the scan voltage source V_{scan}. The first NMOS transistor T₁ₙ can be a TFT.

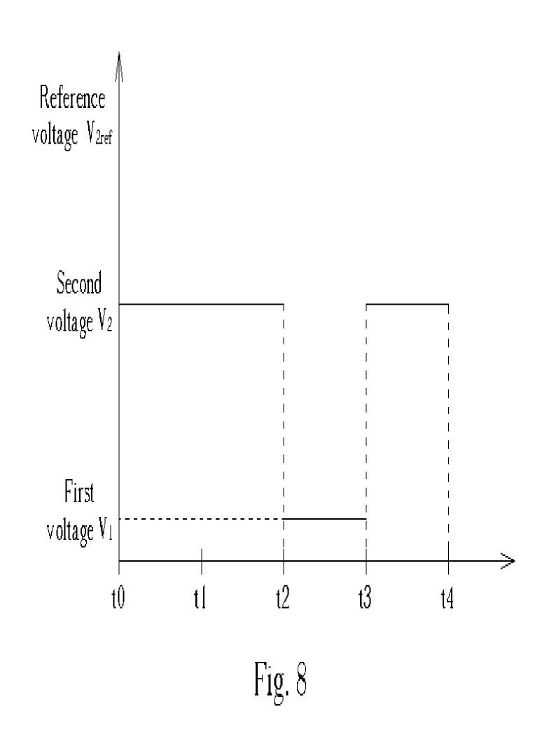

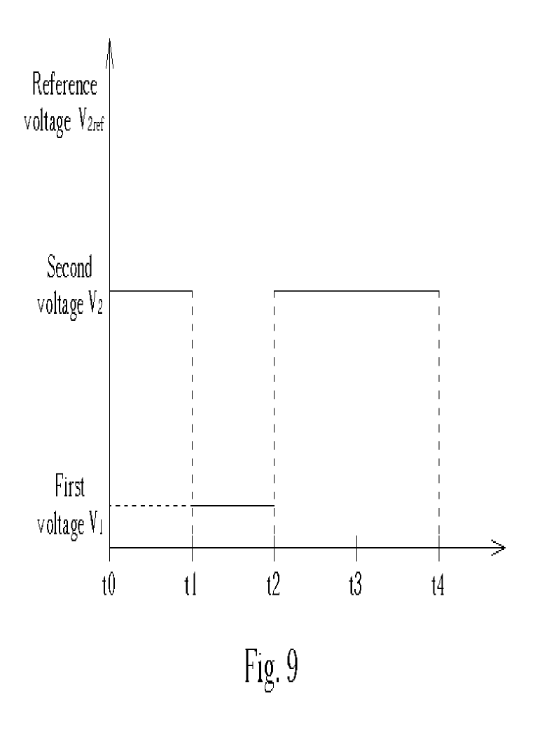

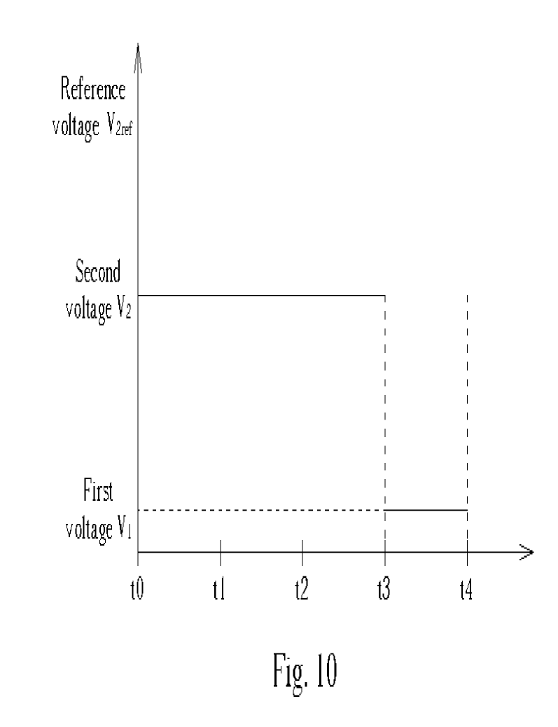

Operations of the driving circuit 60 shown in FIG. 7 are similar to those of the driving circuit 40 shown in FIG. 3. An only difference is that the timing diagram of the second reference voltage source V_{2ref} to vary a voltage at the first end of the capacitor C is different from that of the first reference voltage source V_{1ref}, in the second reference voltage source V_{2ref} the first voltage V₁ being greater than the second voltage V₂. Please refer to FIG. 8 to FIG. 10, which are three distinct timing diagrams of the second reference voltage source V_{2ref} of the driving circuit 60 according to the present invention. Operations of the driving circuit 60 are described as follows: the second reference voltage source V_{2ref} is assumed here to generate the first voltage V₁ and the second voltage V₂ according to the timing diagram shown in FIG. 8. The scan voltage source V_{scan} is controlled to start to output a voltage to turn on the second MOS transistor T₂ so that data at the input end Dᵢₙ of the second MOS transistor T₂ can be transmitted to the output end Dₒᵤₜ of the second MOS transistor T₂ (the first end of the capacitor C) until a voltage at the first end of the capacitor C (the gate T_{1ng} of the first NMOS transistor T₁ₙ) is equal a data voltage V_{data} of the data. Currents flowing through the first NMOS transistor T₁ₙ for controlling the intensity of light emitted by the OLED 86 at this moment vary with the change of a voltage at the gate T_{1ng} of the first NMOS transistor T₁ₙ (the voltage at the first end of the capacitor C, data voltage V_{data}). That is, the higher the data voltage V_{data} of the data is, the greater voltages at the first end of the capacitor C and the gate T_{1ng} of the first NMOS transistor T₁ₙ become. A voltage of a higher voltage level at the gate T_{1ng} of the first NMOS transistor T₁ₙ enables the first NMOS transistor T₁ₙ itself to flow through currents of greater levels and drives the OLED 86 to emit light with greater intensity, accomplishing the function of the driving circuit 60 to adjust the intensity of light emitted by the OLED 86 by determining the data.

After the voltage at the first end of the capacitor C is charged to be equal to the data voltage V_{data} of the data, the scan voltage source V_{scan} is controlled to output a voltage at the time t₁ to turn off the second transistor T₂ and turn off the second transistor T₂, and a voltage of the second reference voltage source V_{2ref} is adjusted sequentially. A voltage difference between the first and the second end of the capacitor C at the time t₁ is equal to a voltage subtracted by the first voltage V₁ from the data voltage V_{data}. Because the second transistor T₁ is kept turned off after the time t₁, charges stored in the capacitor C have no way to flow and the voltage difference between the first and the second end of the capacitor C does not change. As the second reference voltage source V_{2ref}, which is connected to the second end of the capacitor C, generates the first voltage V₁ during the intervals from times t₁ to t₂ and from times t₃ to t₄, a voltage at the first end of the capacitor C (the gate T_{1ng} of the first NMOS transistor T₁ₙ) is equal to the data voltage V_{data}. As the second reference voltage source V_{2ref} generates the second voltage V₂ during the interval from times t₂ to t₃, the voltage at the first end of the capacitor C is equal to the data voltage V_{data}+the second voltage V₂ the first voltage V₁. A voltage decreased at the first end of the capacitor C (the first voltage V₁ the second voltage V₂) forms an electric field E₄, whose direction is opposed to the direction of the electric field E₃, on a region between the source and the gate T_{1ng} of the first NMOS transistor T₁ₙ equivalently. The electric field E₄ is capable of decreasing a number of electrons accumulated in the region between the source and the gate T_{1ng} of the first NMOS transistor T₁ₙ, accomplishing the goal to stabilize the threshold voltage Vₜₕ and to enable the OLED to emit stable light.

In contrast to the prior art, the present invention can provide a method to stabilize the threshold voltage Vₜₕ of a transistor to drive a TFT. Additionally, the present invention has the capability to eliminate the charges accumulated in the FTF to stabilize the threshold voltage Vₜₕ and to enable the OLED to emit stable light.

Following the detailed description of the present invention above, those skilled in the art will readily observe that numerous modifications and alterations of the device may be made while retaining the teachings of the invention. Accordingly, the above disclosure should be construed as limited only by the metes and bounds of the appended claims.

What is claimed is:

1. A method for driving an organic light emitting diode (OLED), the method comprising:
(a) providing a first metal oxide semiconductor (MOS) transistor, whose first and second ends are connected to the OLED and to a first voltage source respectively;
(b) providing a capacitor, whose first end is connected to a gate of the first MOS transistor;
(c) providing a second MOS transistor, whose first end is utilized for inputting data, a second end of the second MOS transistor being connected to the first end of the capacitor;
(d) turning on the second MOS transistor and inputting data from the first end of the second MOS transistor to the second end of the second MOS transistor; and
(e) turning off the second MOS transistor after step (d), and adjusting a voltage at a second end of the capacitor from a first voltage level to a second voltage level different from the first voltage level sequentially.

2. The method of claim 1, wherein the first voltage level is lower than the second voltage level.

3. The method of claim 1, wherein the first voltage level is greater than the second voltage level.

4. The method of claim 1, wherein step (e) comprises: after the voltage at the second end of the capacitor has been adjusted to a voltage level equal to the second voltage level, adjusting the voltage at the second end of the capacitor to a voltage level equal to the first voltage level again.

5. The method of claim 1, wherein the first MOS transistor is a thin film transistor (TFT).

6. The method of claim 1, wherein the first MOS transistor is a PMOS transistor.

7. The method of claim 1, wherein the first MOS transistor is an NMOS transistor.

8. An OLED driving circuit comprising:
an OLED having a first end connected to a first voltage source;
a first MOS transistor having a first end connected to a second end of the OLED and a second end connected to a second voltage source;
a second MOS transistor having a first end connected to a gate of the first transistor, a second end for inputting data, and a gate for inputting a select signal; and
a capacitor having a first end connected to the first end of the second MOS transistor and a second end connected to a reference voltage.

9. The circuit of claim 8, wherein the first MOS transistor is a TFT.

10. The circuit of claim 8, wherein the first MOS transistor is a PMOS transistor.

11. The circuit of claim 8, wherein the first MOS transistor is an NMOS transistor.
